(19) United States
(12) Patent Application Publication
(10) Pub. No.: US 2007/0181653 A1
(43) Pub. Date: Aug. 9, 2007

(54) Magnetic alignment of integrated circuits to each other

(76) Inventors: Lynne M. Michaelson, Austin, TX (US); Robert E. Jones, Austin, TX (US); Scott K. Pozder, Austin, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/350,306

(22) Filed: Feb. 8, 2006

(51) Int. Cl. B23K 31/02

(52) U.S. Cl. 228/123.1

(57) ABSTRACT

Utilizing magnetic features located on different structures having semiconductor devices to align the structures when contacting the structures together. The magnetic features on each structure are of opposite polarity and provide magnetic forces for alignment of the structures. The magnetic forces can also be used to sense position and move the structures into an aligned position. In some examples, the structures include die with semiconductor devices. In one example, the structures are wafers with multiple die. In other examples, one of the structures is a die and the other is a wafer.

### FIELD OF THE INVENTION

The invention relates to a method of combining integrated circuits and, more particularly, to a method for using magnetic features for achieving alignment of the integrated circuits.

### BACKGROUND OF THE INVENTION

In achieving more functionality in a given package, one of the techniques being pursued is combining multiple integrated circuits in the same package. One technique is to stack them, which is referred to as vertical integration. The effect is that by stacking integrated circuits more area for circuitry is available for a given area of the package. Relative to packages, integrated circuits are very thin so very little increase in package height is required when stacking integrated circuits. Also, vertical integration is a way to efficiently combine integrated circuits that are made in substantially different ways to optimize their differing functions. One such example, is an integrated circuit that is optimized for RF is made in a significantly different way than one optimized for logic. Cell phones present a situation in which combining RF integrated circuits and logic integrated circuits is desirable.

Two integrated circuits are attractive for vertical integration because little change, if any, is required in the manufacture of the integrated circuits to be combined as compared to the same integrated circuit made for a stand alone package. The contacts of the two integrated circuits are aligned in a mirror image fashion so that when they are face to face, the contacts match. Alignment, however, is a difficulty because it is not convenient to use typical lithography techniques for alignment because one integrated circuit blocks the view to the other integrated circuit. This has been addressed by inserting an aligning device between the integrated circuits while they are face to face but before they are in contact. This process can be effective but it is quite slow. Also it results in some travel after the aligning operation has been performed so there is opportunity for some misalignment while moving over the travel distance before contact is made. Another issue is that after alignment and contact, the alignment must be maintained until the contact is made permanent. Moving the integrated circuits without a good physical bonding can cause the alignment to be compromised.

Thus, there is a need for a technique for vertically combining integrated circuits that effectively addresses one or more of the issues described above.

### BRIEF DESCRIPTION OF THE DRAWINGS

The foregoing and further and more specific objects and advantages of the invention will become readily apparent to those skilled in the art from the following detailed description of a preferred embodiment thereof taken in conjunction with the following drawings:

FIG. 1 is a top view of a wafer useful in achieving a first embodiment of the invention;

FIG. 2 is a top view of a first integrated circuit and a second integrated circuit useful in achieving the first embodiment of the invention, wherein the first integrated circuit is from the wafer of FIG. 1;

FIG. 3 is a top view of the first and second integrated circuit during an operation for combining the first and second integrated circuits according to the first embodiment of the invention;

FIG. 4 is a side view of the first and second integrated circuits after being aligned according to the first embodiment of the invention;

FIG. 5 is a side view of the first and second integrated circuits after being bonded together according to the first embodiment of the invention;

FIG. 6 is a side view of first and second wafers being combined according to a second embodiment of the invention;

FIG. 7 is a depiction of a system for combining the first and second integrated circuits according to the first embodiment of the invention;

FIG. 8 is a flow diagram of a method useful with regard to both the first and second embodiments of invention;

FIG. 9 is a flow diagram of an alternative method useful with regard to both the first and second embodiments of invention;

FIG. 10 is a graph of force versus position useful in understanding the flow diagram of FIG. 9; and

FIG. 11 is a graph of force versus position useful in understanding the flow diagram of FIG. 8;

### DETAILED DESCRIPTION OF THE INVENTION

Two integrated circuits are aligned by magnetic alignment features, having first and second pole types, present on both integrated circuits. One integrated circuit has its magnetic alignment features in a first pattern and the other integrated circuit has its magnetic alignment features in a second pattern that is a mirror image of the first pattern. One integrated circuit has its magnetic alignment features with the first pole type protruding outward from the surface of the die. The other integrated circuit has its magnetic alignment features with the second pole type protruding outward from the surface of the die. The result is that the magnetic alignment features providing a force pattern allowing for alignment between the two integrated circuits and also for holding the alignment during the time prior to bonding the two integrated circuits together. A similar approach can be used for combining two wafers. This is better understood by reference to the drawings and the following description.

Shown in FIG. 1 is a top view of a semiconductor wafer 10 having a plurality of integrated circuits, one of which is integrated circuit 14.

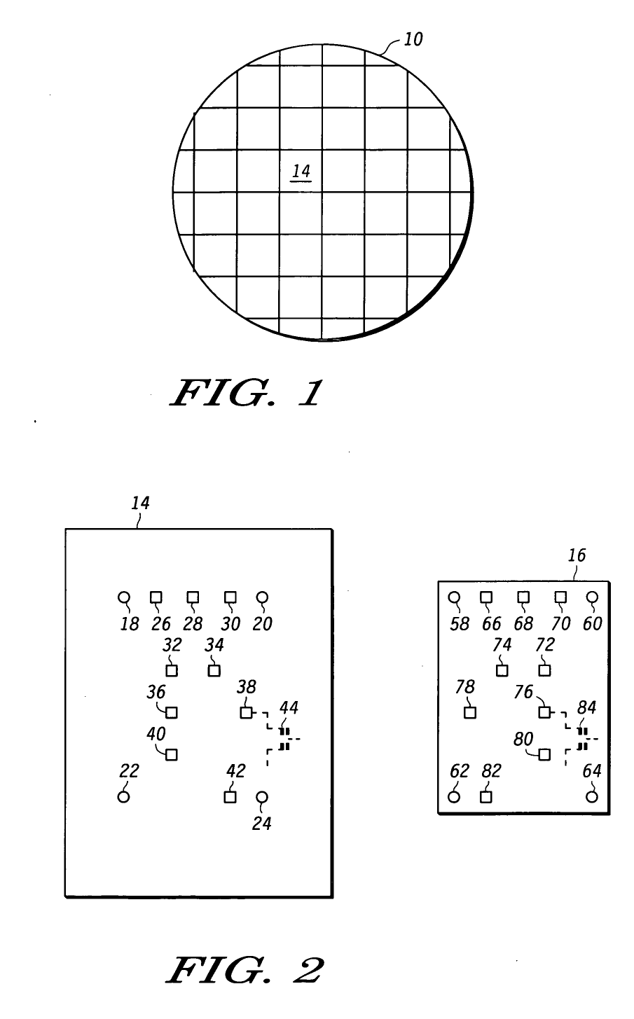

Shown in FIG. 2 is integrated circuit 14 and an integrated circuit 16. Integrated circuits 14 and 16 each provide an electronic function and have contacts and magnetic alignment features on a major surface. Integrated circuit 14 has magnetic alignment features 18, 20, 22, and 24 arranged in a pattern in which they are near corners of integrated circuit 14. Integrated circuit 14, as shown in FIG. 2, has contacts 26, 28, 30, 32, 34, 36, 38, 40, and 42 in an arrangement that can be considered a pattern for connecting to integrated circuit 16. A transistor 44 is shown connected to contact 38. Transistor 44 is merely representative of the many transistors that would be present in an integrated circuit such as integrated circuit 14. Similarly, contacts 26, 28, 30, 32, 34, 36, 38, 40, and 42 are merely representative of all of the contacts on an integrated circuit such as integrated circuit 14. Integrated circuit 16 has magnetic alignment features 58, 60, 62, and 64 that are arranged as a mirror image of the pattern of the magnetic alignment features of integrated circuit 14. Integrated circuit 16 has contacts 66, 68, 70, 72, 74, 76, 78, 80, and 82 arranged for connecting to the contacts of integrated circuit 14. The result is that the contacts of integrated circuit 14 and the contacts of integrated circuit 16 are arranged in patterns that are mirror images of each other. A transistor 84 is shown connected to contact 76. Transistor 84 is merely representative of the many transistors that would be present in an integrated circuit such as integrated circuit 16. Similarly, contacts 66, 68, 70, 72, 74, 76, 78, 80, and 82 are merely representative of all of the contacts on an integrated circuit such as integrated circuit 16.

The contacts are electrically conductive pillars that preferably comprise copper. The magnetic alignment features are electrically conductive pillars that preferably have a copper bottom portion and a cobalt tungsten boron top region. The top region may be conveniently formed by beginning with a copper pillar surrounded by dielectric, similar to the contacts, and then etching back the copper while masking the contacts. Subsequently growing the top region of cobalt tungsten boron on the bottom copper region by plating. Then performing a chemical mechanical polishing step if needed to ensure that the contacts and magnetic alignment features were the same height. The surrounding dielectric is etched back to expose the conductive pillars of copper for the contacts and the cobalt tungsten boron for the magnetic alignment features. To make the cobalt tungsten boron into a permanent magnet, the integrated circuit is exposed to a high magnetic field of preferably about 200 Oersteds which is preferably achieved using an electro-magnet. To provide the opposite pole for the other integrated circuit, the current of the electro-magnet then is simply reversed.

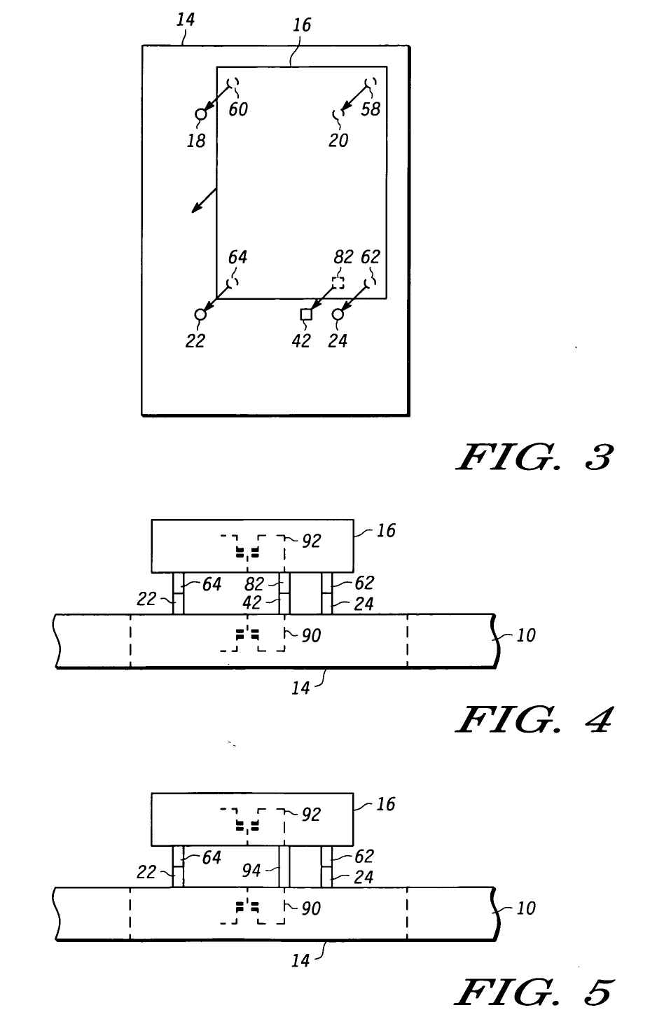

Shown in FIG. 3 are integrated circuits 14 and 16 in the process of being aligned with integrated circuit 16 being brought over integrated circuit 14. Arrows show the direction and distance that integrated circuit 16 needs to move in order to achieve proper alignment. In this view all of the contacts of integrated circuit 14 except contact 42 are covered by integrated circuit 16. Because integrated circuit 16 is inverted in order to combine with integrated circuit 14, the contact 82 and magnetic alignment features 58, 60, 62, and 64 are shown in dotted lines. The only magnetic alignment feature of integrated circuit 14 covered by integrated circuit 16 and shown in FIG. 3 is magnetic alignment feature 20 shown in dotted lines.

Shown in FIG. 4 are integrated circuits 14 and 16 after being aligned and in contact. In this view contact 42 of integrated circuit 14 and contact 82 of integrated circuit 16 are in contact, and magnetic alignment features 22 and 24 of integrated circuit 14 are in contact with magnetic alignment features 64 and 62 of integrated circuit 16, respectively. Because the magnetic alignment features are in contact with opposing polarities, a magnetic force aids in keeping the alignment between wafers. Further during the process of aligning, the magnetic attraction is useful in achieving the alignment. Also shown in FIG. 4 are transistors 90 and 92 connected to contacts 42, and 82, respectively. Transistors 90 and 92 are demonstrative that integrated circuits 14 and 16 contain electronic circuitry.

Shown in FIG. 5 is the bonding of integrated circuit 14 and 16 to form a vertically integrated assembly of two integrated circuits. Contacts 42 and 82 are merged to form a single contact 94. This provides a mechanical bond as well as good electrical contact. This can be achieved simply by applying heat. The temperature is desirably kept as low as possible to ensure there is no damage to the integrated circuits. A consequence of the low temperature, however, is that little if any merging may occur among the cobalt tungsten boron features. This can result in poor electrical coupling between the contacted magnetic alignment features which in some designs, designs that do not depend on good electric coupling between the magnetic alignment features, may not be a problem. In other embodiments, however, it may be desirable to achieve good electrical coupling between magnetic alignment features. In such cases, the contacting surfaces of the magnetic alignment features can be coated with a metal, such as copper, that will react even at the low temperature in order and thereby achieve the desired electrical coupling.

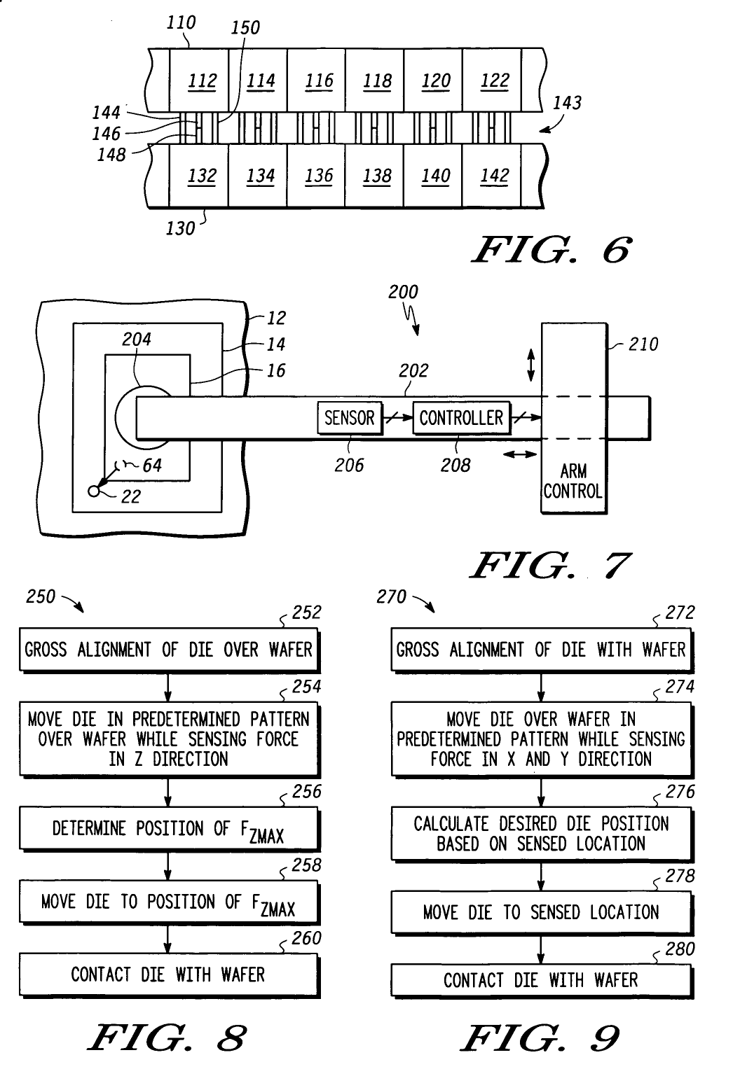

Shown in FIG. 6 are two wafers, wafers 110 and 130. Wafer 110 comprises integrated circuits 112, 114, 116, 118, 120, and 122 as well as other integrated circuits not shown. Wafer 130 comprises integrated circuits 132, 134, 136, 138, 140, and 142 as well as other integrated circuits not shown. Wafers 110 and 130 are aligned and bonded together by features 143 comprised of contacts and magnetic alignment features of integrated circuits 112, 114, 116, 118, 120, and 122 of wafer 110 and integrated circuits 132, 134, 136, 138, 140, and 142 of wafer 130. As an example, integrated circuit 112 has a magnetic alignment feature 146 aligned to and in contact with a magnetic alignment feature 148 of integrated circuit 132. Further integrated circuits 112 and 132 have contacts that have been merged to form contacts 144 and 150. This shows that two wafers can be bonded together using the alignment of magnetic alignment features. Also, when bonding wafers or even major sections of wafers together, it may only be necessary to have one magnetic alignment feature per integrated circuit to achieve the needed alignment and further may be sufficient to hold the wafers together sufficiently to maintain alignment until bonding occurs.

Shown in FIG. 7 is an apparatus 200 useful in aligning a die to a wafer or a wafer to a wafer using magnetic alignment features. Apparatus 200 comprises an arm 202, a die holder 204 at the end of arm 202 for holding a die or wafer, a sensor 206 for detecting and converting lateral force and/or vertical force to electronic signals, a controller 208 for receiving and interpreting the electronic signals from the sensor, an arm control 210 for moving the arm in the x or y directions as shown by the double ended arrows. The sensor is preferably a piezoelectric module that can sense force in the x and y directions and/or the z direction. Controller 208 controls arm 202 by way of arm control 210 in response to the pressure being sensed through sensor 206. In this particular example of use of apparatus 200, integrated circuit 16 is aligned to integrated circuit 14 which is present in wafer 10. As shown in FIG. 7, magnetic alignment feature 64 is to be aligned to magnetic alignment feature 22. The other magnetic alignment features not shown also need to be aligned as well. When controller 208 determines that alignment has been achieved, controller 208 directs holder 204 to release integrated circuit 16. The magnetic force holds integrated circuit 16 aligned to integrated circuit 14 while the combination is moved to a location where bonding can be performed.

Shown in FIG. 8 is a method 250 for aligning a die to a wafer. Die and integrated circuit are terms that are commonly used interchangeably. An integrated circuit is a die, but a die can refer to things such as discrete devices and integrated passive devices as well as to integrated circuits. The method begins with a step 252 which provides a gross alignment using standard pick and place capabilities. The die is then moved, step 254, to determine a force pattern in the z direction (up/down). When the force of attraction, which is the z direction, is at a peak, there is alignment. This is shown in FIG. 11; that the location of alignment is the location of peak force Fzmax. The location of peak force Fzmax is thus determined as shown as step 256. After determination of the Fzmax location, the die is moved to that location, step 258, and then the die is placed on the underlying die or wafer, step 260, so that contact is made.

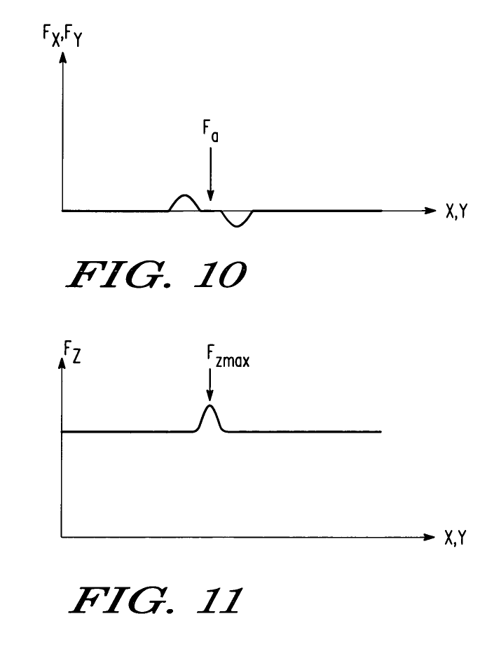

Shown in FIG. 9 is an alternative method 270 for aligning a die to a wafer. The method begins with a step 272 which provides a gross alignment using standard pick and place capabilities. The die is then moved, step 274, to determine a force pattern in the x,y direction (lateral which in this case could also be called horizontal). In this case the magnitude of the force increases as the magnetic alignment features approach each other; when they are aligned, the force becomes zero; and when they begin separating, the magnitude of the force increases again but in the opposite direction. This is shown in the graph of FIG. 10. The magnetic force is attractive so that if the die is to the left of the aligned position, then the force is to the right, which is positive. If the die is to the right of the aligned position, the force is to the left, which is negative. Thus, alignment is present when the die is between the locations of the positive and negative force peaks, which is shown as the location of force Fa in FIG. 10. When this force pattern is achieved, that location is calculated, step 276, or otherwise determined. The die is moved to that location, step 278, and then placed on the underlying wafer, step 280, so that contact is made. With contact made, the die and wafer are aligned and are held in place so that the combination of the two can maintain alignment while being moved and bonded.

Various other changes and modifications to the embodiments herein chosen for purposes of illustration will readily occur to those skilled in the art. For example, alignment can be achieved not just x,y forces or just the z force, but also a combination of x,y forces and z forces. Controller 208 would thus take into account both force types in selecting the optimum location for releasing the die. To the extent that such modifications and variations do not depart from the spirit of the invention, they are intended to be included within the scope thereof which is assessed only by a fair interpretation of the following claims.

1. A method comprising:
forming a first structure, the first structure including semiconductor material;
forming a second structure, the second structure including semiconductor material;
contacting the first structure with the second structure, wherein the contacting further includes:
sensing forces generated by magnetic fields between the first structure and the second structure; and
aligning the first structure with respect to second structure based on the sensing.

2. The method of claim 1 wherein the first structure includes a first semiconductor die and the second structure includes a second semiconductor die, wherein the contacting the first structure with the second structure includes contacting the first die with the second die.

3. The method of claim 1 wherein:
the first structure includes a first plurality of magnetic features of a first magnetic polarity and the second structure includes a second plurality of magnetic features of a second magnetic polarity opposite of the first magnetic polarity; and
the sensing forces generated by magnetic fields between the first structure and the second structure includes sensing forces generated by magnetic fields between the first plurality of magnetic features and the second plurality of magnetic features.

4. The method of claim 3 wherein:
the forming the first structure includes magnetizing the first plurality of magnetic features; and
the forming the second structure includes magnetizing the second plurality of magnetic features.

5. The method of claim 3 wherein the contacting the first structure with the second structure includes magnetically coupling magnetic features of the first plurality of magnetic features with magnetic features of the second plurality of magnetic features.

6. The method of claim 3 wherein the contacting further includes electrically coupling a magnetic feature of the first plurality with a magnetic feature of the second plurality.

7. The method of claim 1 wherein first structure includes a first plurality of electrical contacts located at a first major surface of the first structure and the second structure includes a second plurality of electrical contacts located at a second major surface of the second structure, wherein the contacting includes electrically contacting electrical contacts of the first plurality with electrical contacts of the second plurality.

8. The method of claim 1 wherein the first structure is characterized as a semiconductor die and the second structure is characterized as a wafer.

9. The method of claim 1 wherein the first structure is characterized as a wafer and the second structure is characterized as a wafer.

10. The method of claim 1 wherein the first structure includes a first integrated circuit and the second structure includes a second integrated circuit, wherein the contacting includes electrically coupling the first integrated circuit with the second integrated circuit.

11. The method of claim 1 wherein:
the first structure includes a first major surface and the second structure includes a second major surface;
the contacting includes positioning the first structure with respect to the second structure such that the first major surface faces the second major surface; and
the sensing includes sensing forces in a direction generally perpendicular to the first major surface and the second major surface when the first major surface and the second major surface are positioned to face each other.

12. The method of claim 1 wherein:
the first structure includes a first major surface and the second structure includes a second major surface;
the contacting includes positioning the first structure with respect to the second structure such that the first major surface faces the second major surface; and
the sensing includes sensing forces in a direction generally parallel to the first major surface and the second major surface when the first major surface and the second major surface are positioned to face each other.

13. The method of claim 1 wherein the contacting includes moving the first structure in a plurality of positions with respect to the second structure and the sensing includes sensing forces at each of the plurality of positions.

14. The method of claim 1 wherein the aligning the first structure with respect to second structure based on the sensing includes aligning the first structure with respect to the second structure at a position based upon a sensed force profile generated from the sensing.

15. A method comprising:
forming a first structure, the first structure including a semiconductor device, the first structure including a first magnetic feature and a second magnetic feature;
forming a second structure, the second structure including a second semiconductor device, the second structure including a third magnetic feature and a fourth magnetic feature; and
contacting the first structure with the second structure to provide the first structure and the second structure in a contacted position with each other, wherein in the contacted position, the first magnetic feature is magnetically coupled to the third magnetic feature and the second magnetic feature is magnetically coupled to the fourth magnetic feature.

16. The method of claim 15 wherein the first structure includes a semiconductor die and the second structure includes a semiconductor die wherein the contacting includes contacting the first semiconductor die with the second semiconductor die.

17. The method of claim 15 wherein first structure includes a first semiconductor device electrically coupled to the first magnetic feature and the second structure includes a second semiconductor device electrically coupled to the third magnetic feature, wherein the contacting includes electrically coupling the first semiconductor device to the second semiconductor device via the first magnetic feature and the third magnetic feature.

18. The method of claim 15 wherein the contacting further includes sensing forces generated by magnetic fields between the first structure and the second structure including magnetic fields between the first magnetic feature and the third magnetic feature and between the second magnetic feature and the fourth magnetic feature.

19. The method of claim 18 wherein the contacting further includes aligning the first structure with the second structure based on the sensing.

20. The method of claim 15 wherein the first structure is characterized as a wafer and the second structure is characterized as a wafer.

21. The method of claim 15 wherein the first magnetic feature and the second magnetic feature are of a first magnetic polarity and wherein the third magnetic feature and the fourth magnetic feature are of a second magnetic polarity opposite of the first magnetic polarity.

22. An apparatus comprising:
a first die, the first die including a first semiconductor device, the first die including a first magnetic feature and a second magnetic feature; and
a second die, the second die including a second semiconductor device, the second die is attached to the first die, the second die including a third magnetic feature and a fourth magnetic feature, the first magnetic feature is magnetically coupled to the third magnetic feature and the second magnetic feature is magnetically coupled to the fourth magnetic feature.
